(19) United States
(12) Patent Application Publication
(10) Pub. No.: US 2025/0077146 A1
(43) Pub. Date: Mar. 6, 2025

(54) MANAGEMENT SYSTEM CAPABLE OF PROVIDING SUBSCRIPTION SERVICE OF AVAILABLE IMAGE FORMING APPARATUS EVEN WHEN IMAGE FORMING APPARATUS IS IN OFFLINE STATE, CONTROL METHOD FOR MANAGEMENT SYSTEM, AND STORAGE MEDIUM

(71) Applicant: CANON KABUSHIKI KAISHA, Tokyo (JP)

(72) Inventor: YOSHIHIRO TSUKADA, Ibaraki (JP)

(21) Appl. No.: 18/805,462

(22) Filed: Aug. 14, 2024

(30) Foreign Application Priority Data
Aug. 30, 2023 (JP) 2023-139810

(51) Int. Cl. G06F 3/12

(52) U.S. Cl. CPC G06F 3/126; G06F 3/1203

(57) ABSTRACT

A mechanism capable of providing a subscription service of an available image forming apparatus even when the image forming apparatus is in an offline state is provided. In a management system, a communication terminal transmits usage situation information of an image forming apparatus and contract information to a service management server via a device management server based on information obtained from the image forming apparatus. The service management server performs an available-or-not determining processing of the image forming apparatus based on the received usage situation information and the received contract information, and transmits the result of the available-or-not determining processing to the communication terminal via the device management server. In the case that the result of the available-or-not determining processing that has been received indicates that the image forming apparatus is available for use, the communication terminal issues a usage restriction release instruction to the image forming apparatus.

### BACKGROUND OF THE INVENTION

### Field of the Invention

The present invention relates to a management system, a control method for the management system, and a storage medium.

### Description of the Related Art

A subscription service of an image forming apparatus is being used. In the subscription service of the image forming apparatus, the image forming apparatus is delivered to a user, and the user is able to use the image forming apparatus for a fixed fee up to the maximum number of printed pages corresponding to a plan contracted (subscribed to) by the user during a contract period (see Japanese Laid-Open Patent Publication (kokai) No. 2021-160203). As a result, the user is able to perform printing, scanning, copying, and the like at low cost without purchasing the image forming apparatus.

In the subscription service of the image forming apparatus, based on the usage situation of the image forming apparatus, a determination of available-or-not of the image forming apparatus (whether or not the image forming apparatus is available for use) is performed. For example, a management server of the subscription service obtains the cumulative number of printed pages from the image forming apparatus via the Internet, and determines whether or not this cumulative number of printed pages exceeds the maximum number of printed pages corresponding to the contracted plan.

However, in the above-mentioned conventional art, when performs the determination of available-or-not of the image forming apparatus, it is assumed that the image forming apparatus is connected to the Internet. On the other hand, among users of image forming apparatuses, there are a certain number of users who wish to use the image forming apparatus without connecting it to the Internet, or users who do not have a suitable infrastructure environment. With the above-mentioned conventional art, such users are not able to use the subscription service of the image forming apparatus.

### SUMMARY OF THE INVENTION

The present invention provides a mechanism capable of providing a subscription service of an available image forming apparatus even when the image forming apparatus is in an offline state.

Accordingly, the present invention provides a management system comprising an image forming apparatus, a server that manages information for providing a subscription service of the image forming apparatus, and a communication terminal that communicates with the server via a network and directly communicates with the image forming apparatus that is not connected to the network. The server comprises at least one processor, and a memory coupled to the processor storing instructions that, when executed by the processor, cause the processor to function as an obtaining unit that obtains usage situation information of the image forming apparatus that has been transmitted from the communication terminal, and contract information regarding the subscription service of the image forming apparatus, a determining unit that determines whether or not the image forming apparatus is available for use based on the usage situation information of the image forming apparatus and the contract information, and a transmitting unit that transmits a determination result obtained by the determining unit. The communication terminal comprises at least one processor, and a memory coupled to the processor storing instructions that, when executed by the processor, cause the processor to function as a first transmitting unit that transmits the usage situation information of the image forming apparatus and the contract information based on information obtained from the image forming apparatus, an obtaining unit that obtains the determination result transmitted from the server, and a second transmitting unit that, in a case that the determination result indicates that the image forming apparatus is available for use, transmits, to the image forming apparatus, an instruction for controlling the image forming apparatus to be available for use.

According to the present invention, it is possible to provide the subscription service of the available image forming apparatus even when the image forming apparatus is in the offline state.

Further features of the present invention will become apparent from the following description of exemplary embodiments with reference to the attached drawings.

### BRIEF DESCRIPTION OF THE DRAWINGS

FIG. 1 is a block diagram that shows a configuration example of a management system according to an embodiment of the present invention.

FIG. 2 is a block diagram that schematically shows a hardware configuration of an image forming apparatus shown in FIG. 1.

FIG. 3 is a block diagram that schematically shows a hardware configuration of a device management server shown in FIG. 1.

FIG. 4 is a block diagram that schematically shows a hardware configuration of a service management server shown in FIG. 1.

FIG. 5 is a block diagram that schematically shows a hardware configuration of a communication terminal shown in FIG. 1.

FIG. 6 is a sequence diagram that shows a procedure of processes for a user to start using a subscription service in the management system shown in FIG. 1.

FIG. 7 is a diagram that shows an example of screens displayed on an operation unit of the communication terminal in the sequence of FIG. 6.

FIG. 8 is a sequence diagram that shows a procedure of processes when executing a print job in the management system shown in FIG. 1.

FIG. 9 is a diagram that shows an example of screens displayed on the operation unit of the communication terminal in the sequence of FIG. 8.

FIG. 10 is a sequence diagram that shows a procedure of processes when executing a copy job in the management system shown in FIG. 1.

FIG. 11 is a diagram that shows an example of screens displayed on the operation unit of the communication terminal in the sequence of FIG. 10.

### DESCRIPTION OF THE EMBODIMENTS

The present invention will now be described in detail below with reference to the accompanying drawings showing embodiments thereof.

Hereinafter, an embodiment of the present invention will be described with reference to the drawings. In the following drawings, the same or corresponding components, component apparatuses, and component units are denoted by the same reference numerals. It should be noted that the following embodiment does not limit the present invention as defined by the claims, and not all of the combinations of features described in the present embodiment are necessarily essential to the solving means of the present invention.

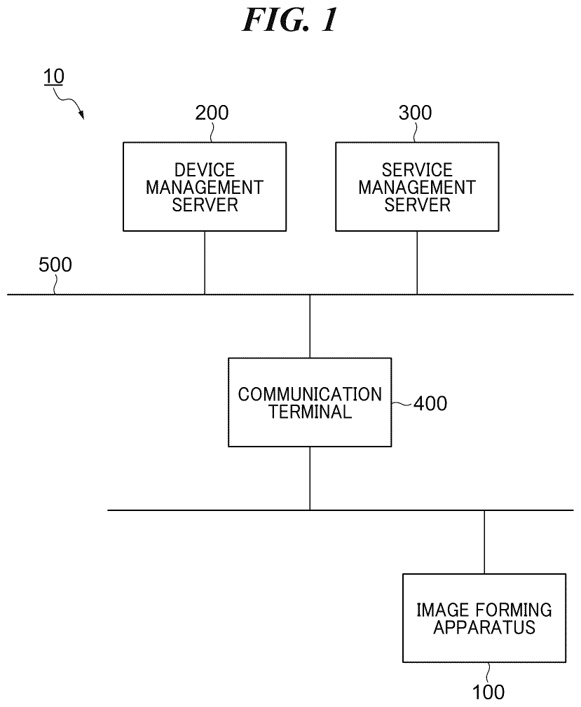

FIG. 1 is a block diagram that shows a configuration example of a management system 10 according to the present embodiment. As shown in FIG. 1, the management system 10 includes an image forming apparatus 100, a device management server 200, a service management server 300, and a communication terminal 400.

The management system 10 provides a subscription service of an image forming apparatus (hereinafter, simply referred to as “a subscription service”) that allows a user to use the image forming apparatus at low cost without purchasing the image forming apparatus. The subscription service is a service that allows the user to use the image forming apparatus for a fixed fee up to the maximum number of printed pages corresponding to a plan contracted (subscribed to) by the user during a contract period. In the subscription service, an image forming apparatus is delivered to a user who has made a contract to use the subscription service. The user is able to use functions of this image forming apparatus that correspond to the contracted plan.

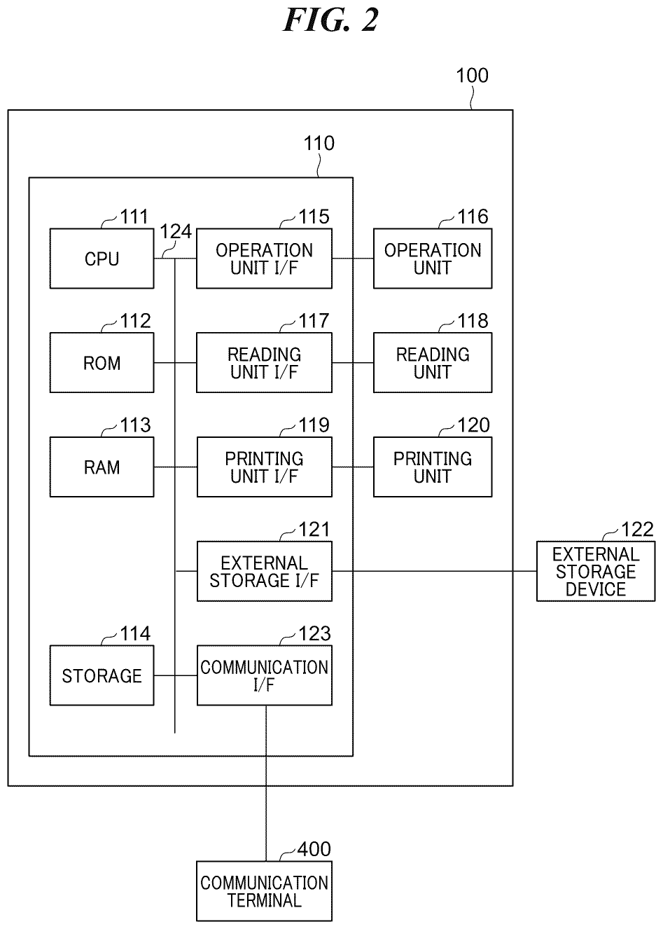

The image forming apparatus 100 obtains contract information notified by the service management server 300, and stores the contract information in a storage 114 shown in FIG. 2, which will be described below. This contract information is used to control whether or not each function in the image forming apparatus 100 is available for use. It should be noted that details of the contract information and details of the control of the image forming apparatus 100 based on the contract information will be described below.

The communication terminal 400 is, for example, a mobile terminal such as a smartphone, a tablet terminal, or a notebook type personal computer (a notebook type PC). The communication terminal 400 communicates with the device management server 200 and the service management server 300 via a communication network 500 such as the Internet. In addition, the communication terminal 400 performs one-to-one communication with the image forming apparatus 100 that is not connected to the communication network 500. For example, the communication terminal 400 is connected to the image forming apparatus 100 by a USB cable, and communicates with the image forming apparatus 100 via the USB cable. In addition, the communication terminal 400 performs short-range wireless communication such as communication based on Bluetooth Low Energy (BLE) or communication based on Wi-Fi Direct. As described above, in the present embodiment, the image forming apparatus 100 is in an offline state in which the image forming apparatus 100 is not connected to the communication network 500, and is able to communicate only with the communication terminal 400.

The device management server 200 retains the contract information notified by the service management server 300, and provides this contract information to the image forming apparatus 100 via the communication terminal 400. In addition, the device management server 200 obtains, from the communication terminal 400, usage situation information (described below) that has been transmitted by the image forming apparatus 100, and provides the obtained usage situation information to the service management server 300. It should be noted that a communication protocol such as the hypertext transfer protocol (hereinafter, referred to as “HTTP”) is used for communication between the communication terminal 400 and the device management server 200, and for communication between the device management server 200 and the service management server 300.

It should be noted that in the present embodiment, the configuration in which the communication terminal 400 communicates with the service management server 300 via the device management server 200 will be described, but the present invention is not limited to this configuration. For example, the communication terminal 400 may be configured to directly communicate with the service management server 300 via the communication network 500.

FIG. 2 is a block diagram that schematically shows a hardware configuration of the image forming apparatus 100 shown in FIG. 1. As shown in FIG. 2, the image forming apparatus 100 includes a control unit 110, an operation unit 116, a reading unit 118, and a printing unit 120. The control unit 110 includes a central processing unit (a CPU) 111, a read only memory (a ROM) 112, a random-access memory (a RAM) 113, a storage 114, an operation unit interface (an operation unit I/F) 115, a reading unit I/F 117, a printing unit I/F 119, an external storage I/F 121, and a communication I/F 123. The CPU 111, the ROM 112, the RAM 113, the storage 114, the operation unit I/F 115, the reading unit I/F 117, the printing unit I/F 119, the external storage I/F 12, and the communication I/F 123 are connected to each other via a system bus 124.

The CPU 111 controls the operations of the image forming apparatus 100. The CPU 111 reads out a program, which has been stored in the ROM 112 or the storage 114, into the RAM 113 and executes the program. The program is, for example, a control program, and the CPU 111 executes the control program to perform various kinds of control such as reading control and printing control.

The ROM 112 stores the program executed by the CPU 111. In addition, the ROM 112 stores a boot program, font data, etc.

The RAM 113 is a main storage memory of the CPU 111. The RAM 113 is used as a working area for the CPU 111 and as a temporary storage area for loading the programs that have been stored in the ROM 112 and the storage 114. In addition, the RAM 113 is also used to temporarily store image data.

The storage 114 stores the image data, print data, an address book, shortcuts, various kinds of programs, and various kinds of setting information. In the present embodiment, the storage 114 is assumed to be a flash memory, but an auxiliary storage device such as a solid state drive (an SSD), a hard disk drive (an HDD), or an embedded multi media card (an eMMC) may also be used as the storage 114.

The operation unit I/F 115 connects the operation unit 116 and the control unit 110. The operation unit 116 includes hard keys and a touch panel. The touch panel is configured by attaching a touch panel sheet to a display. The operation unit 116 accepts operations from the user through the hard keys and displays a screen via the touch panel.

The reading unit I/F 117 connects the reading unit 118 and the control unit 110. The reading unit 118 reads an image of a document and generates image data based on the image of the document. The image data generated by the reading unit 118 is subjected to a character recognition processing, is transmitted to an external apparatus, and/or is printed on a printing sheet.

The printing unit I/F 119 connects the printing unit 120 and the control unit 110. The CPU 111 transfers image data that should be printed (image data to be printed) to the printing unit 120 via the printing unit I/F 119. The printing unit 120 prints the image on a recording sheet fed from a sheet feeding cassette. The method for printing the image may be an electrophotographic method in which the image is printed by using toner, or an inkjet method in which the image is printed by using ink.

The external storage I/F 121 connects an external storage device 122 and the control unit 110. The CPU 111 stores the image data in the external storage device 122 via the external storage I/F 121. In the present embodiment, it is assumed that the external storage I/F 121 is a USB interface and the external storage device 122 is a USB memory, but the present invention is not limited to this. For example, the external storage device 122 may be an SD card or the like.

The communication I/F 123 controls transmission and reception of data to and from the external apparatus. In the present embodiment, the image forming apparatus 100 communicates with the communication terminal 400 by using the communication I/F 123. It should be noted that the communication between the image forming apparatus 100 and the communication terminal 400 is, for example, as described above, communication via the USB cable connecting the communication terminal 400 and the image forming apparatus 100, communication based on BLE, or communication based on Wi-Fi Direct.

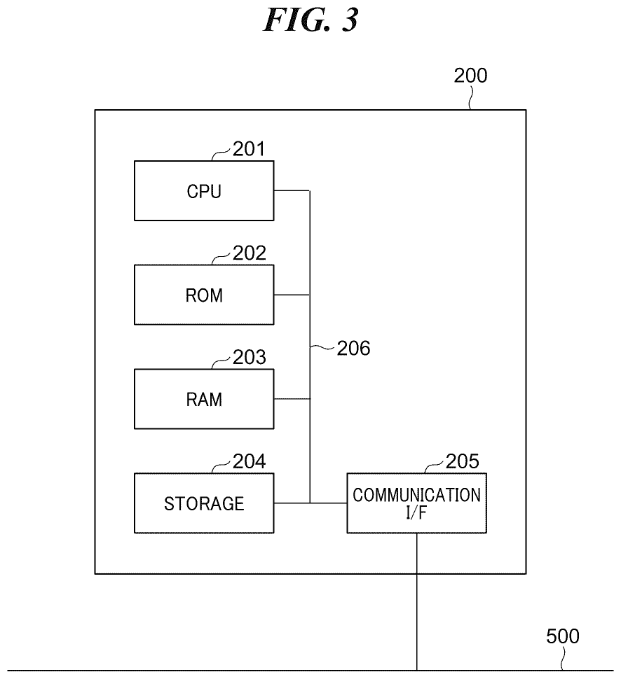

FIG. 3 is a block diagram that schematically shows a hardware configuration of the device management server 200 shown in FIG. 1. As shown in FIG. 3, the device management server 200 includes a CPU 201, a ROM 202, a RAM 203, a storage 204, and a communication I/F 205. The CPU 201, the ROM 202, the RAM 203, the storage 204, and the communication I/F 205 are connected to each other via a system bus 206.

The CPU 201 performs processes such as calculation, determination, and control of data and commands in accordance with a program that have been stored in the ROM 202, the RAM 203, or the storage 204. The RAM 203 is used as a temporary storage area when the CPU 201 performs various kinds of processes. The storage 204 stores an operating system (an OS), application software, programs, and the like. In addition, the storage 204 stores device identification information of the image forming apparatus that is to be managed by the device management server 200, the contract information (to be described below) obtained from the service management server 300, and the like.

The communication I/F 205 uses a wireless local area network (a wireless LAN) conforming to a standard such as IEEE802.11a or a wired LAN, and transmits and receives data to and from equipment (an apparatus) via the communication network 500 by using a protocol such as the transmission control protocol/internet protocol (TCP/IP). The system bus 206 transmits and receives data between the components connected to the system bus 206.

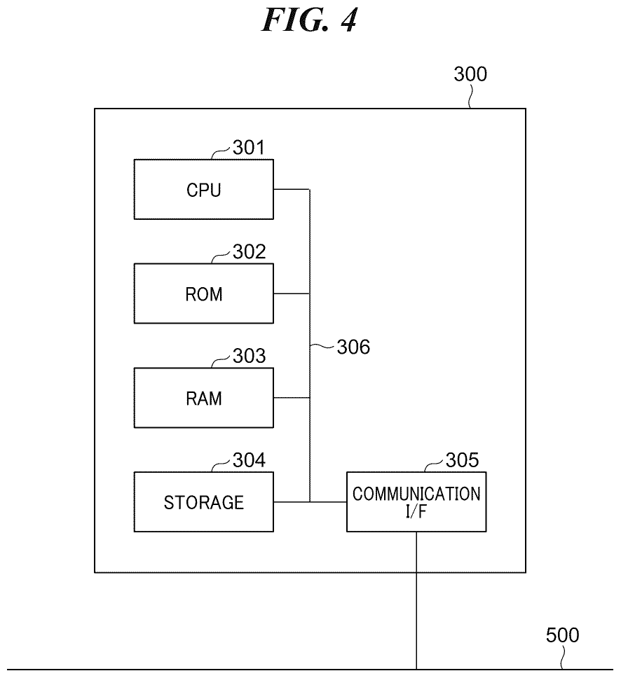

FIG. 4 is a block diagram that schematically shows a hardware configuration of the service management server 300 shown in FIG. 1. As shown in FIG. 4, the service management server 300 includes a CPU 301, a ROM 302, a RAM 303, a storage 304, and a communication I/F 305. The CPU 301, the ROM 302, the RAM 303, the storage 304, and the communication I/F 305 are connected to each other via a system bus 306. It should be noted that although the service management server 300 and the device management server 200 execute different programs (different processes), their hardware configurations are basically the same. Therefore, the description of the hardware configuration of the service management server 300 is similar to the description of the hardware configuration of the device management server 200, and therefore will be omitted here.

It should be noted that in the present embodiment, the configuration in which the device management server 200 and the service management server 300 are separate apparatuses will be described, but the present invention is not limited to this configuration. For example, the respective functions of the device management server 200 and the respective functions of the service management server 300 may be realized by a single server. Furthermore, the respective functions of the device management server 200 and the respective functions of the service management server 300 may be realized by a server system including three or more servers. Moreover, the respective functions of the device management server 200 and the respective functions of the service management server 300 may be realized by using a server on a cloud.

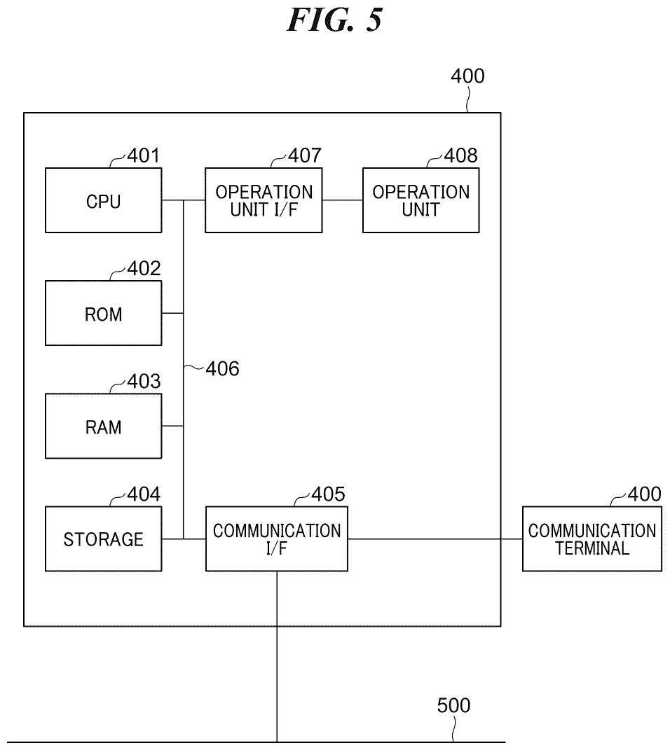

FIG. 5 is a block diagram that schematically shows a hardware configuration of the communication terminal 400 shown in FIG. 1. As shown in FIG. 5, the communication terminal 400 includes a CPU 401, a ROM 402, a RAM 403, a storage 404, a communication I/F 405, an operation unit I/F 407, and an operation unit 408. The CPU 401, the ROM 402, the RAM 403, the storage 404, the communication I/F 405, and the operation unit I/F 407 are connected to each other via a system bus 406.

The CPU 401 performs processes such as calculation, determination, and control of data and commands in accordance with a program that have been stored in the ROM 402, the RAM 403, or the storage 404. The RAM 403 is used as a temporary storage area when the CPU 401 performs various kinds of processes. The storage 404 stores an operating system (an OS), application software, programs, and the like. The system bus 406 transmits and receives data between the components connected to the system bus 406. The communication I/F 405 uses a wireless LAN conforming to a standard such as IEEE802.11a or a wired LAN, and transmits and receives data to and from equipment (an apparatus) via the communication network 500 by using a protocol such as the transmission control protocol/internet protocol (TCP/IP). In addition, the communication I/F 405 performs one-to-one data communication with the image forming apparatus 100. The operation unit I/F 407 connects the operation unit 408 and the CPU 401. The operation unit 408 includes hard keys and a touch panel. The touch panel is configured by attaching a touch panel sheet to a display. The operation unit 408 accepts operations from the user through the hard keys and displays a screen via the touch panel.

It should be noted that in the present embodiment, as described above, since the communication terminal 400 is assumed to be a mobile terminal such as a smartphone, a tablet terminal, or a notebook type PC, FIG. 5 shows the configuration in which the operation unit 408 is included in the communication terminal 400. However, the communication terminal 400 is not limited to such a mobile terminal, and may be, for example, a desktop type PC. In the case that the communication terminal 400 is a desktop type PC, the operation unit 408 and a display unit (not shown) are not included in the communication terminal 400, but are configured to be externally attached to the communication terminal 400.

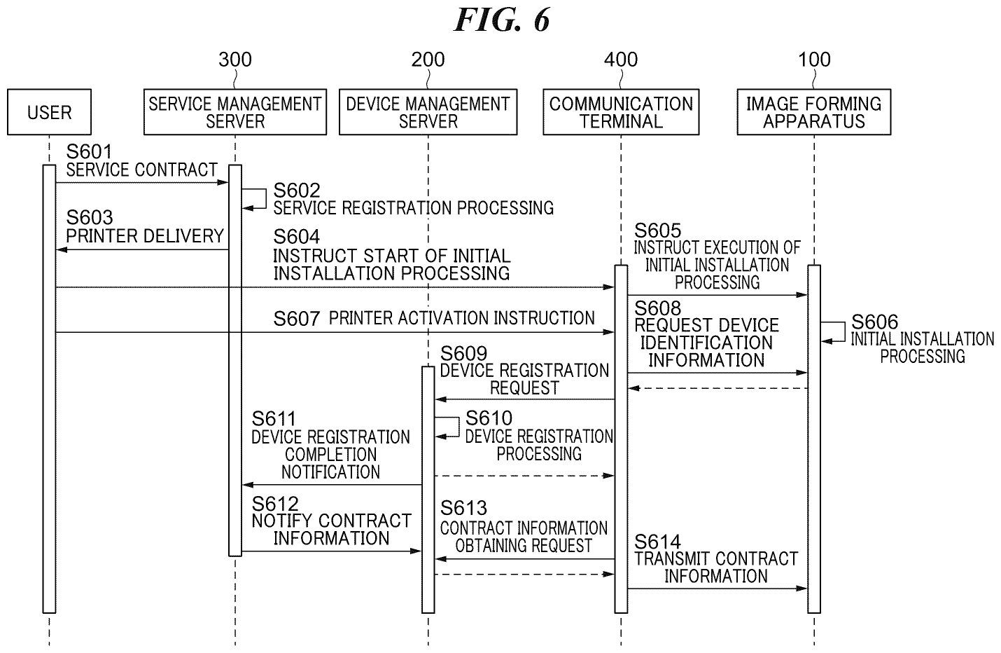

FIG. 6 is a sequence diagram that shows a procedure of processes for the user to start using the subscription service in the management system 10 shown in FIG. 1. It should be noted that in the present embodiment, as an example, a case will be described in which the user accesses a site managed by the service management server 300 from an information processing apparatus (not shown) and makes a service contract. It should be noted that in FIG. 6, the processes performed by the image forming apparatus 100 are realized by the CPU 111 executing the program that has been stored in the ROM 112 or the storage 114. The processes performed by the device management server 200 are realized by the CPU 201 executing the program that has been stored in the ROM 202 or the storage 204. The processes performed by the service management server 300 are realized by the CPU 301 executing the program that has been stored in the ROM 302 or the storage 304. The processes performed by the communication terminal 400 are realized by the CPU 401 executing the program that has been stored in the ROM 402 or the storage 404.

As shown in FIG. 6, first, the user accesses the site managed by the service management server 300 from the information processing apparatus and makes the service contract for using the subscription service (S (step) 601). In the present embodiment, as an example, it is assumed that the service contract has been made with a plan that has been selected by the user from a plurality of plans with the different maximum numbers of printed pages.

Next, the service management server 300 performs a service registration processing (S602). In the service registration processing, information about the user who has made the service contract and information about the plan that the user has contracted (has subscribed to) are registered in association with a printer that will be delivered to the user.

Next, the service management server 300 makes an arrangement for delivery of the printer that has been registered in S602. As a result, the image forming apparatus 100, which is the printer that has been registered in S602, is delivered to the user (S603).

The user who has received the image forming apparatus 100 unpacks the image forming apparatus 100. In addition, the user instructs the communication terminal 400 to start an initial installation processing (S604). In accordance with the instruction received from the user, the communication terminal 400 instructs the image forming apparatus 100 to execute the initial installation processing (S605). At this time, the communication terminal 400 performs one-to-one communication such as communication via the USB cable, communication based on BLE, or communication based on Wi-Fi Direct with the image forming apparatus 100. In the initial installation processing, initial settings such as country setting, language setting, and time setting are performed.

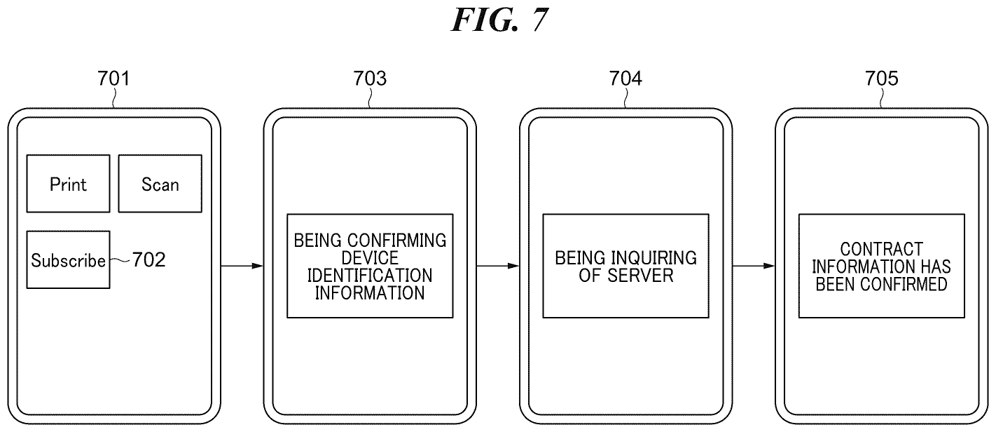

Next, the user operates a mobile application screen 701 shown in FIG. 7 that has been displayed on the operation unit 408 of the communication terminal 400 to issue an instruction to activate the printer (a printer activation instruction) (S607). Specifically, as the printer activation instruction, the user presses a “Subscribe” button 702 on the mobile application screen 701. The “Subscribe” button 702 is an operation button for performing setting, updating, and the like of the contract information. In response to the printer activation instruction received from the user, the communication terminal 400 requests device identification information from the image forming apparatus 100 (S608). It should be noted that the operation unit 408 of the communication terminal 400 displays a screen 703 shown in FIG. 7, which indicates that the device identification information is being confirmed, during a period from when the device identification information is requested until the device identification information is received from the image forming apparatus 100.

In response to the request received from the communication terminal 400, the image forming apparatus 100 transmits the device identification information of the image forming apparatus 100 to the communication terminal 400. The device identification information of the image forming apparatus 100 is a media access control address (an MAC address) of the image forming apparatus 100 or a serial number of the image forming apparatus 100.

The communication terminal 400 transmits a device registration request together with the device identification information of the image forming apparatus 100 to the device management server 200 (S609). At this time, the operation unit 408 of the communication terminal 400 displays a screen 704 shown in FIG. 7, which indicates that the server is being queried. It should be noted that the screen 704 is displayed on the operation unit 408 until the contract information, which is a response to an obtaining request in S613 that will be described below, is received.

The device management server 200 performs a device registration processing that registers the received device identification information (S610). Next, the device management server 200 returns the result of the device registration processing to the image forming apparatus 100. In addition, the device management server 200 transmits a device registration completion notification, which includes the device identification information of the image forming apparatus 100 that has been registered, to the service management server 300 (S611).

The service management server 300 creates the contract information based on information associated with the device identification information included in the received device registration completion notification, and notifies the device management server 200 of this contract information (S612). The contract information is information used for activation when the initial settings of the image forming apparatus 100 are performed, and includes information for determining that the contract has been concluded (has been made). In addition, the contract information includes information indicating an application corresponding to the contracted plan, and license information of this application. It should be noted that the contract information does not include detailed information about the plan that the user has contracted (has subscribed to), such as information about the maximum number of printed pages.

The device management server 200 retains, in the storage 204, the contract information notified by the service management server 300. Then, when the device management server 200 receives a request to obtain the contract information (the obtaining request of the contract information) from the communication terminal 400 in S613, the device management server 200 notifies the communication terminal 400 of the retained contract information in an HTTP response. It should be noted that this obtaining of the contract information is a request to collectively obtain contract states of a plurality of services, and is not a communication performed for each service.

The communication terminal 400 stores the received contract information in the storage 404. At this time, the operation unit 408 of the communication terminal 400 displays a screen 705 shown in FIG. 7, which indicates that the contract information has been confirmed. In addition, the communication terminal 400 transmits the received contract information to the image forming apparatus 100 (S614).

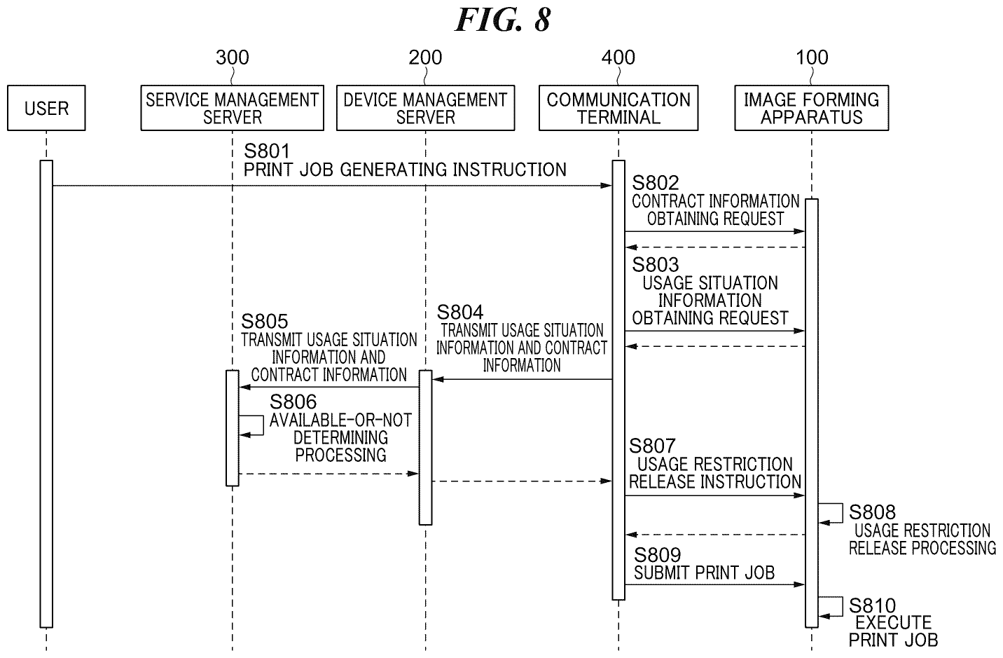

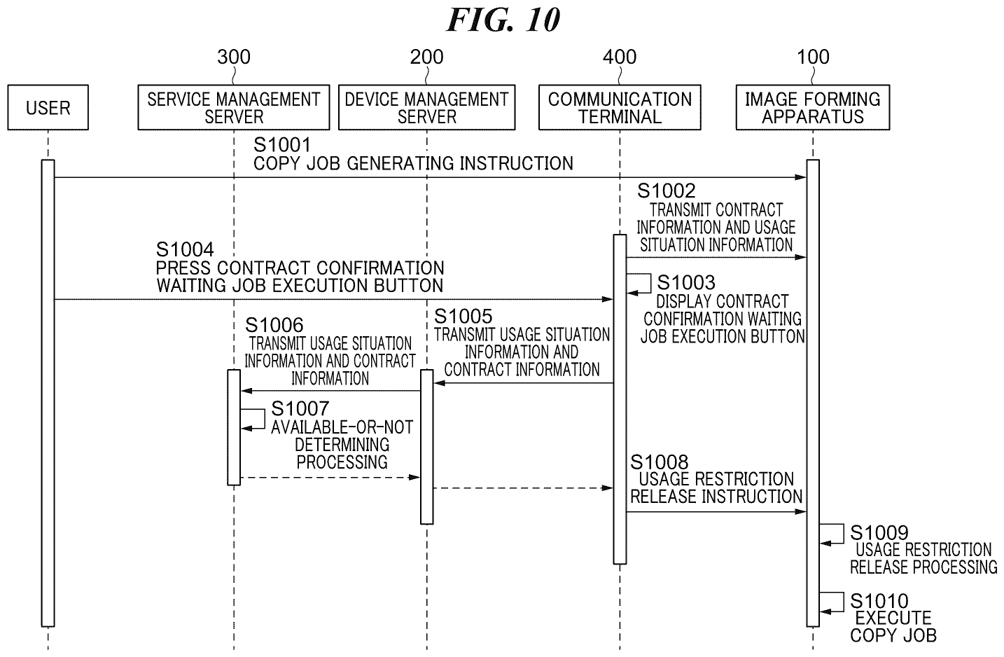

The image forming apparatus 100 sets the received contract information. This contract information is stored in the storage 114 or the like. It should be noted that at this time point, the image forming apparatus 100 has been controlled so that all of its basic functions such as a printing function, a scanning function, a copying function, etc., are not yet available for use. In the present embodiment, when the service management server 300 determines that the image forming apparatus 100 is available for use in a sequence shown in FIG. 8 described below or a sequence shown in FIG. 10 described below, the basic functions permitted for use by the user in the plan contracted (subscribed to) by the user, among the printing function, the scanning function, and the copying function, become available for use. The above is the procedure of the processes for the user to start using the subscription service in the management system 10.

FIG. 8 is a sequence diagram that shows a procedure of processes when executing a print job in the management system 10 shown in FIG. 1. It should be noted that in FIG. 8, the processes performed by the image forming apparatus 100 are realized by the CPU 111 executing the program that has been stored in the ROM 112 or the storage 114. The processes performed by the device management server 200 are realized by the CPU 201 executing the program that has been stored in the ROM 202 or the storage 204. The processes performed by the service management server 300 are realized by the CPU 301 executing the program that has been stored in the ROM 302 or the storage 304. The processes performed by the communication terminal 400 are realized by the CPU 401 executing the program that has been stored in the ROM 402 or the storage 404.

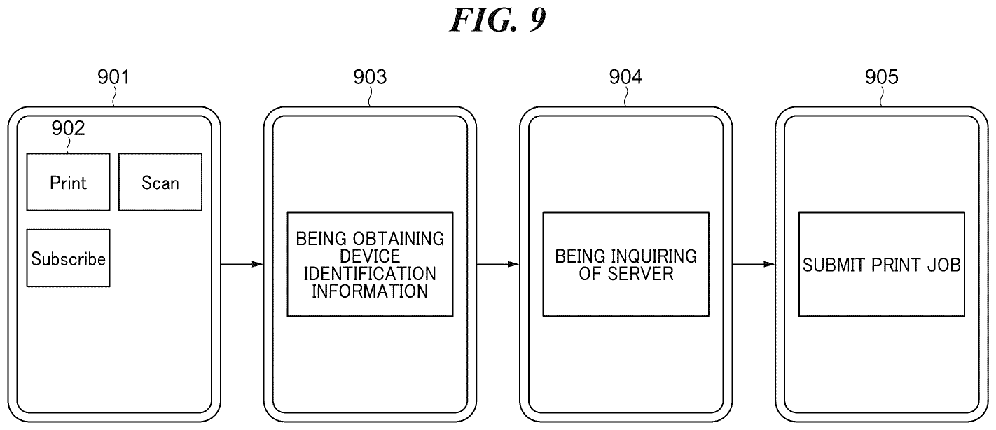

As shown in FIG. 8, the user who is a contractor (a subscriber) to the subscription service operates a mobile application screen 901 shown in FIG. 9 that has been displayed on the operation unit 408 of the communication terminal 400 to issue an instruction to generate a print job to be submitted into the image forming apparatus 100 (a print job generating instruction) (S801). Specifically, the user presses a “Print” button 902 on the mobile application screen 901 displayed on the operation unit 408. It should be noted that when issuing the print job generating instruction, the user designates setting values used to generate the print job such as the number of printed pages, etc., on a setting screen (not shown). When the user presses the “Print” button 902, a screen 903 shown in FIG. 9 is displayed on the operation unit 408 of the communication terminal 400. It should be noted that the screen 903 is displayed on the operation unit 408 until the usage situation information that will be described below and the contract information are obtained from the image forming apparatus 100.

Upon receiving the print job generating instruction, the communication terminal 400 requests the image forming apparatus 100 to obtain the contract information (transmits a contract information obtaining request to the image forming apparatus 100) (S802). Upon receiving the contract information obtaining request, the image forming apparatus 100 transmits, to the communication terminal 400, the contract information that has been set in the sequence of FIG. 6. It should be noted that as described above, this contract information does not include the detailed information about the plan that the user has contracted (has subscribed to), such as the information about the maximum number of printed pages.

Next, the communication terminal 400 requests the image forming apparatus 100 to obtain the usage situation information of the image forming apparatus 100 (transmits a usage situation information obtaining request to the image forming apparatus 100) (S803). Upon receiving the usage situation information obtaining request, the image forming apparatus 100 transmits the usage situation information to the communication terminal 400. This usage situation information includes a print job history indicating the cumulative number of printed pages in the image forming apparatus 100, the remaining amount of toner, etc. It should be noted that in the present embodiment, the print job history is reset to “0” on the first day of a period during which the maximum number of printed pages is specified in the plan contracted (subscribed to) by the user. For example, in the case that the user has contracted (has subscribed to) a plan that allows printing up to 200 pages per month, the print job history is reset to “0” at midnight on the first day of the month.

Next, the communication terminal 400 adds the number of printed pages designated by the user in S801 to the received usage situation information. The communication terminal 400 transmits, to the device management server 200, the usage situation information, to which the number of printed pages has been added, and the above-mentioned contract information (S804). At this time, a screen 904 shown in FIG. 9 is displayed on the operation unit 408 of the communication terminal 400. It should be noted that the screen 904 is displayed on the operation unit 408 until a result of an available-or-not determining processing of the image forming apparatus 100 performed by the service management server 300 is received.

Next, the device management server 200 transmits the received usage situation information and the above-mentioned contract information to the service management server 300 (S805).

Next, the service management server 300 performs the available-or-not determining processing of the image forming apparatus 100 (a processing of determining whether or not the image forming apparatus 100 is available for use) based on the usage situation information and the contract information that have been received (S806). For example, in S806, in the case that the contract information managed by the service management server 300 does not match the received contract information, or in the case that the falsification of the print job history such as the print job history being less than the previous value has been detected, it is determined that the image forming apparatus 100 is not available for use.

In addition, in S806, whether or not the image forming apparatus 100 is available for use (available-or-not of the image forming apparatus 100) is determined based on whether or not a total value of the number of printed pages included in the received usage situation information and the cumulative number of printed pages indicated by the print job history exceeds the maximum number of printed pages. In determining whether or not the image forming apparatus 100 is available for use (available-or-not of the image forming apparatus 100) based on the maximum number of printed pages, the service management server 300 specifies the maximum number of printed pages from the received contract information, and determines whether or not the total value exceeds the maximum number of printed pages. In the case that the total value does not exceed the maximum number of printed pages, the service management server 300 determines that the image forming apparatus 100 is available for use, and on the other hand, in the case that the total value exceeds the maximum number of printed pages, the service management server 300 determines that the image forming apparatus 100 is not available for use. The service management server 300 transmits the result of the available-or-not determining processing to the communication terminal 400 via the device management server 200.

Next, in the case that the result of the available-or-not determining processing that has been received indicates that the image forming apparatus 100 is available for use, the communication terminal 400 issues a usage restriction release instruction to the image forming apparatus 100 (S807).

In accordance with the usage restriction release instruction, the image forming apparatus 100 performs a usage restriction release processing for releasing the usage restriction on the basic functions (S808). As a result, the basic functions permitted for use by the user in the plan contracted (subscribed to) by the user, among the printing function, the scanning function, and the copying function of the image forming apparatus 100, become available for use. When the usage restriction release processing is completed, the image forming apparatus 100 notifies the communication terminal 400 of the completion of the usage restriction release processing.

Upon receiving the notification of the completion of the usage restriction release processing, the communication terminal 400 submits the print job generated in accordance with the instruction received in S801 into the image forming apparatus 100 (S809). At this time, a screen 905 shown in FIG. 9 is displayed on the operation unit 408 of the communication terminal 400. The image forming apparatus 100 executes the submitted print job (S810). The above is the procedure of the processes when executing the print job in the management system 10.

According to the embodiment described above, in the management system 10, the communication terminal 400 transmits the usage situation information of the image forming apparatus 100 and the contract information to the service management server 300 via the device management server 200 based on the information obtained from the image forming apparatus 100. The service management server 300 performs the available-or-not determining processing of the image forming apparatus 100 based on the usage situation information and the contract information that have been received, and transmits the result of the available-or-not determining processing to the communication terminal 400 via the device management server 200. In the case that the result of the available-or-not determining processing that has been received indicates that the image forming apparatus 100 is available for use, the communication terminal 400 issues the usage restriction release instruction to the image forming apparatus 100. That is, since the communication terminal 400 performs communication for releasing the usage restriction of the image forming apparatus 100 instead of the image forming apparatus 100, there is no need to connect the image forming apparatus 100 to the communication network 500. As a result, it is possible to provide the subscription service that is available for use even when the image forming apparatus 100 is in the offline state in which the image forming apparatus 100 is not connected to the communication network 500.

In the embodiment described above, the information obtained from the image forming apparatus 100 is the information transmitted from the image forming apparatus 100 as a response to the obtaining request made to the image forming apparatus 100 by the communication terminal 400 in accordance with receiving the instruction to generate the job to be submitted into the image forming apparatus 100. As a result, in the configuration in which the instruction to generate the job to be submitted into the image forming apparatus 100 is received by the communication terminal 400, it is possible to provide the subscription service that is available for use even when the image forming apparatus 100 is in the offline state.

In addition, in the embodiment described above, the communication terminal 400 is a terminal used by the user who is the contractor (the subscriber) to the subscription service of the image forming apparatus 100. As a result, by just preparing the communication terminal 400, the user is able to use the subscription service of the image forming apparatus 100 without connecting the image forming apparatus 100 to the communication network 500.

In addition, in the embodiment described above, the communication terminal 400 is connected to the image forming apparatus 100 by the USB cable, and communicates with the image forming apparatus 100 via the USB cable. As a result, even when the image forming apparatus 100 is in the offline state, the communication terminal 400 is able to obtain, from the image forming apparatus 100, the information required to execute the available-or-not determining processing.

In addition, in the embodiment described above, the communication terminal 400 communicates with the image forming apparatus 100 via short-range wireless communication. As a result, even if the communication terminal 400 is not connected to the image forming apparatus 100 in the offline state via the USB cable, the communication terminal 400 is able to obtain, from the image forming apparatus 100, the information required to execute the available-or-not determining processing.

It should be noted that in the sequence of FIG. 8, the configuration, in which the communication terminal 400 adds the number of printed pages designated by the user in S801 to the usage situation information received from the image forming apparatus 100, has been described, but the present invention is not limited to this configuration. For example, a configuration, in which the communication terminal 400 notifies the image forming apparatus 100 of the number of printed pages designated by the user in S801 when making the usage situation information obtaining request in S803, and the image forming apparatus 100 transmits, to the communication terminal 400, the usage situation information including the number of printed pages, may be adopted.

In addition, in the present embodiment, a configuration, in which the user issues the job generating instruction to the image forming apparatus 100 instead of the communication terminal 400, may be adopted. Hereinafter, as an example, a procedure of processes in the case that the user has issued a copy job generating instruction (an instruction to generate a copy job) to the image forming apparatus 100 will be described.

FIG. 10 is a sequence diagram that shows a procedure of processes when executing the copy job in the management system 10 shown in FIG. 1. It should be noted that in FIG. 10, the processes performed by the image forming apparatus 100 are realized by the CPU 111 executing the program that has been stored in the ROM 112 or the storage 114. The processes performed by the device management server 200 are realized by the CPU 201 executing the program that has been stored in the ROM 202 or the storage 204. The processes performed by the service management server 300 are realized by the CPU 301 executing the program that has been stored in the ROM 302 or the storage 304. The processes performed by the communication terminal 400 are realized by the CPU 401 executing the program that has been stored in the ROM 402 or the storage 404.

As shown in FIG. 10, the user who is the contractor (the subscriber) to the subscription service operates the operation unit 116 of the image forming apparatus 100 to issue the copy job generating instruction (S1001). It should be noted that when issuing the copy job generating instruction, the user designates setting values used to generate the copy job such as the number of printed pages, etc., on a setting screen (not shown).

Upon receiving the copy job generating instruction, the image forming apparatus 100 transmits a push notification of the contract information and the usage situation information to the communication terminal 400 used by this user (S1002). It should be noted that the method of notifying the contract information and the usage situation information may be a method in which the communication terminal 400 periodically polls the image forming apparatus 100. This contract information is the contract information set in the sequence of FIG. 6 described above. In addition, this usage situation information includes the print job history, the remaining amount of toner, the number of printed pages designated by the user in S1001, etc.

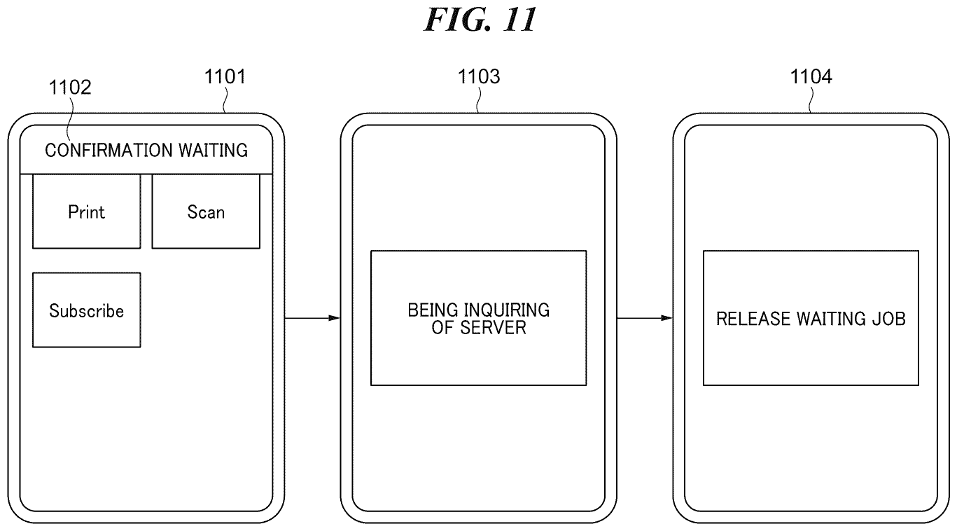

The communication terminal 400, which has received the contract information and the usage situation information from the image forming apparatus 100, causes a mobile application screen 1101 that is shown in FIG. 11 and is displayed on the operation unit 408 to display a contract confirmation waiting job execution button 1102 (S1003).

Next, when the user presses the contract confirmation waiting job execution button 1102 (S1004), the communication terminal 400 transmits, to the device management server 200, the contract information and the usage situation information that have been received from the image forming apparatus 100 (S1005). At this time, a screen 1103 shown in FIG. 11 is displayed on the operation unit 408 of the communication terminal 400. It should be noted that the screen 1103 is displayed on the operation unit 408 until the result of the available-or-not determining processing of the image forming apparatus 100 performed by the service management server 300 is received.

The device management server 200 transmits, to the service management server 300, the contract information and the usage situation information that have been received (S1006).

Similar to S806 described above, the service management server 300 performs the available-or-not determining processing of the image forming apparatus 100 based on the contract information and the usage situation information that have been received (S1007). The result of the available-or-not determining processing is transmitted to the communication terminal 400 via the device management server 200.

Next, in the case that the result of the available-or-not determining processing that has been received indicates that the image forming apparatus 100 is available for use, the communication terminal 400 issues a usage restriction release instruction to the image forming apparatus 100 (S1008).

In accordance with the usage restriction release instruction, the image forming apparatus 100 performs a usage restriction release processing for releasing the usage restriction on the basic functions (S1009). Next, the image forming apparatus 100 executes the copy job generated in accordance with the instruction received in S1001 (S1010). At this time, a screen 1104 shown in FIG. 11 is displayed on the operation unit 408 of the communication terminal 400. The above is the procedure of the processes when executing the copy job in the management system 10.

In the embodiment described above, the information obtained by the communication terminal 400 from the image forming apparatus 100 is the information transmitted from the image forming apparatus 100 when the image forming apparatus 100 receives the copy job generating instruction from the user. As a result, in the configuration in which the job generating instruction is received by the image forming apparatus 100, it is possible to provide the subscription service that is available for use even when the image forming apparatus 100 is in the offline state.

It should be noted that the available-or-not determining processing described above does not have to be performed every time a job is executed. For example, in the case that there is a sufficient margin up to the maximum number of printed pages, the available-or-not determining processing may be performed once for every several jobs among the jobs executed in one day. As a result, it is possible to reduce the communication load between the apparatuses in the management system 10 for performing the available-or-not determining processing.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-139810. filed on Aug. 30, 2023, which is hereby incorporated by reference herein in its entirety.

What is claimed is:

1. A management system comprising:
an image forming apparatus;
a server that manages information for providing a subscription service of the image forming apparatus; and
a communication terminal that communicates with the server via a network and directly communicates with the image forming apparatus that is not connected to the network, and
wherein the server comprises
at least one processor; and
a memory coupled to the processor storing instructions that, when executed by the processor, cause the processor to function as:
an obtaining unit that obtains usage situation information of the image forming apparatus that has been transmitted from the communication terminal, and contract information regarding the subscription service of the image forming apparatus;
a determining unit that determines whether or not the image forming apparatus is available for use based on the usage situation information of the image forming apparatus and the contract information; and
a transmitting unit that transmits a determination result obtained by the determining unit, and
the communication terminal comprises
at least one processor; and
a memory coupled to the processor storing instructions that, when executed by the processor, cause the processor to function as:
a first transmitting unit that transmits the usage situation information of the image forming apparatus and the contract information based on information obtained from the image forming apparatus;
an obtaining unit that obtains the determination result transmitted from the server; and
a second transmitting unit that, in a case that the determination result indicates that the image forming apparatus is available for use, transmits, to the image forming apparatus, an instruction for controlling the image forming apparatus to be available for use.

2. The management system according to claim 1, wherein
the information obtained from the image forming apparatus is information transmitted from the image forming apparatus as a response to an obtaining request made to the image forming apparatus by the communication terminal in accordance with receiving an instruction to generate a job to be submitted into the image forming apparatus from a user.

3. The management system according to claim 1, wherein
the information obtained from the image forming apparatus is information transmitted from the image forming apparatus when the image forming apparatus receives a job generating instruction from a user.

4. The management system according to claim 2, wherein
the user is a contractor to the subscription service of the image forming apparatus, and
the communication terminal is a terminal used by the user.

5. The management system according to claim 3, wherein
the user is a contractor to the subscription service of the image forming apparatus, and
the communication terminal is a terminal used by the user.

6. The management system according to claim 1, wherein
the communication terminal is connected to the image forming apparatus by a USB cable and communicates with the image forming apparatus via the USB cable.

7. The management system according to claim 1, wherein
the communication terminal wirelessly communicates with the image forming apparatus based on Bluetooth Low Energy (BLE).

8. A control method for a management system comprising an image forming apparatus; a server that manages information for providing a subscription service of the image forming apparatus; and a communication terminal that communicates with the server via a network and directly communicates with the image forming apparatus that is not connected to the network,
the control method comprising:
causing the server to obtain usage situation information of the image forming apparatus that has been transmitted from the communication terminal, and contract information regarding the subscription service of the image forming apparatus;
causing the server to determine whether or not the image forming apparatus is available for use based on the usage situation information of the image forming apparatus and the contract information;
causing the server to transmit a determination result of whether or not the image forming apparatus is available for use;
causing the communication terminal to transmit the usage situation information of the image forming apparatus and the contract information based on information obtained from the image forming apparatus;
causing the communication terminal to obtain the determination result transmitted from the server; and
causing the communication terminal to, in a case that the determination result indicates that the image forming apparatus is available for use, transmit, to the image forming apparatus, an instruction for controlling the image forming apparatus to be available for use.

9. A non-transitory computer-readable storage medium storing a program for causing a computer to execute a control method for a management system comprising an image forming apparatus; a server that manages information for providing a subscription service of the image forming apparatus; and a communication terminal that communicates with the server via a network and directly communicates with the image forming apparatus that is not connected to the network,
the control method comprising:
causing the server to obtain usage situation information of the image forming apparatus that has been transmitted from the communication terminal, and contract information regarding the subscription service of the image forming apparatus;
causing the server to determine whether or not the image forming apparatus is available for use based on the usage situation information of the image forming apparatus and the contract information;
causing the server to transmit a determination result of whether or not the image forming apparatus is available for use;
causing the communication terminal to transmit the usage situation information of the image forming apparatus and the contract information based on information obtained from the image forming apparatus;
causing the communication terminal to obtain the determination result transmitted from the server; and
causing the communication terminal to, in a case that the determination result indicates that the image forming apparatus is available for use, transmit, to the image forming apparatus, an instruction for controlling the image forming apparatus to be available for use.
